(19) United States
(12) Patent Application Publication
(10) Pub. No.: US 2003/0068255 A1
(43) Pub. Date: Apr. 10, 2003

(54) Device for dosing a gaseous reducing agent

(76) Inventors: Bernd Maurer, Balve (DE); Georg Huthwohl, Soest (DE)

Correspondence Address: Patent Law Offices of Rick Martin, P.C., 416 Coffman Street, Longmont, CO, 80501, US

(21) Appl. No.: 10/266,057

(22) Filed: Oct. 7, 2002

(30) Foreign Application Priority Data
Oct. 5, 2001 (DE) DE 201 16379.9

(51) Int. Cl. B01D 53/56

(52) U.S. Cl. 422/172; 422/168

(57) ABSTRACT

A device for dosing a gaseous reducing agent for the supply into the exhaust gas system of a diesel engine, comprising a line terminating in the exhaust gas system, in which in the supply direction of the reducing agent are connected a vaporizer, a pressure reducer as well as a dosing valve, and a buffer container is provided connected in the supply line and preceding the pressure reducer.

### CROSS REFERENCE APPLICATIONS

This application claims priority from German application no. 201 16 379.9 filed Oct. 5, 2001.

### FIELD OF INVENTION

The present invention relates to a device for dosing a gaseous reducing agent for the supply into the exhaust gas system of a diesel engine. The present invention comprises a line terminating in the exhaust gas system into which are connected, in the direction of supply of the reducing agent, a vaporizer, a buffering vessel, a pressure reducer and a dosing valve.

### BACKGROUND OF THE INVENTION

It is well known in the art of diesel engines to reduce the noxious substances in the exhaust gas flow by performing a denoxing process. Such a denoxing process has become known as the SCR method (Selective Catalytic Reduction). In order to be able to carry out the reduction of the nitric oxides on a catalyst suitable for this purpose, a reducing agent must first be added to the exhaust gas flow. The reducing agent most commonly employed is ammonia (NH₃). As previously described in DE 200 21 401 U1, the NH₃ is drawn in the liquid state from a tank, generally a pressure tank. The withdrawn NH₃ is conducted via a supply line from the NH₃ tank into the exhaust gas system. A dosing valve actuated by a control mechanism is connected in the supply line.

As a function of the operating state of the diesel engine different quantities of nitric oxide are present in the exhaust gas flow at different times. In order to be able to carry out the reduction of the nitric oxides on the SCR catalyst as intended, the quantity of NH₃ as reducing agent must matched to the nitric oxide quantity present in the exhaust gas flow. Consequently, it is essential that the supplied NH₃ quantity is sufficient to ensure a complete as reduction as possible of the nitric oxides contained in the exhaust gas flow. On the other hand, for the best possible utilization of resources, the intent is to inject into the exhaust gas flow only such a quantity of NH₃ as is actually required for carrying out the denoxing process as defined.

For dosing gaseous NH₃ it is known to vaporize the NH₃ drawn from an NH₃ tank. For example, by using an NH₃ bottle with a vaporizer connected in the NH₃ supply line. After the vaporizer are a pressure reducer and a dosing valve. The vaporizer turns the liquid NH₃ into gas so that on the dosing valve gaseous NH₃ is present. In order for a defined NH₃ gas quantity to be delivered via the dosing valve in front of the dosing valve is a pressure reducer to ensure that at the input side of the dosing valve highly constant pressure conditions are obtained. While the pressure reducers conventionally applied in such devices are capable of bringing about the desired pressure reduction, these pressure reducers cannot completely compensate for the pressure peaks generated in the vaporizer when vaporizing the NH₃. Therefore pressure peaks, even if they occur in attenuated form, also can be detected on the dosing valve. Since, as a rule, the vaporization process takes place with the dosing valve open, these pressure peaks lead to too high an NH₃ dosing.

Building on this discussed prior art, the present invention addresses the problem of further developing a device according to the prior art such that the dosing accuracy in the delivery of gaseous NH₃ by the dosing valve is improved. This problem is solved according to the present invention by connecting in the supply line and preceding the pressure reducer a buffer container.

### SUMMARY OF THE INVENTION

The primary aspect of the present invention is to provide increased dosing accuracy at the dosing valve.

In the present invention a buffer container is connected in the NH₃ supply line such that the pressure peaks generated when vaporizing the liquid reducing agent are buffered out through this compensation vessel. Consequently, in the present invention there is no danger of pressure peaks punching through the pressure reducer and the dosing valve and increasing the dose reducing agent above the planned amount. Consequently, exactly the intended reducing agent quantity is delivered by the dosing valve for injection into the exhaust gas system of the diesel engine.

In one embodiment the buffer vessel is in front of the vaporizer and can be connected directly into the supply line or be connected via a line branch. In the preferred embodiment the buffer container is the reducing agent tank already present in any case. The supply line between tank and vaporizer in such an implementation is conducting in both directions. In this implementation not only are the pressure peaks generated during vaporizing of the liquid reducing agent buffered out by the tank, but the supply line between tank and vaporizer is continuously flushed by the generated reducing agent gas. A further advantage in such an implementation is the subsequent condensation of the gaseous reducing agent in the tank, releasing heat during condensation. This heat release augments the heating and pressure build-up in the tank. This is of special advantage in a tank that has already been largely emptied, so that the virtually complete emptying is possible. This is especially sensible when using interchangeable containers, such as bottles.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

FIG. 1 is a schematic representation in the manner of a block circuit diagram of the present invention.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

The present invention 1 comprises a docking station, overall denoted by 2, in which two interchangeable NH₃ containers 3, 4 are disposed. Both interchangeable NH₃ containers 3, 4 are connected to a vehicle-side supply line system 5 via quick coupling S₁, S₂. With a main valve V₁ or V₂ the pressurization takes place of the supply line system 5 with the NH₃ contained in the interchangeable NH₃ containers 3, 4. Via a shuttle check valve RWV either the interchangeable NH₃ container 3 or the interchangeable NH₃ container 4 can be connected to the line system succeeding the shuttle check valve RWV. After the shuttle check valve RWV is a vaporizer H₁ for vaporizing liquid NH₃ which has been withdrawn from one of the two interchangeable NH₃ containers 3 or 4. Following the vaporizer H₁ is a pressure reducer DM, which is directly set to a desired pressure, for example 3 bar. The pressure reducer DM serves for reducing the pressure at the input side on pressure reducer DM to one which is desired for dosing and injecting an NH₃ dose into the exhaust gas system of a diesel engine. At the output side of pressure reducer DM, the supply line is monitored for temperature and pressure with a temperature sensor T and a pressure sensor P₁. After the pressure reducer DM is a dosing valve V₃ with which the delivery of the NH₃ required in each instance takes place. The output of dosing valve V₃ is monitored with respect to its pressure by a further pressure sensor P₂.

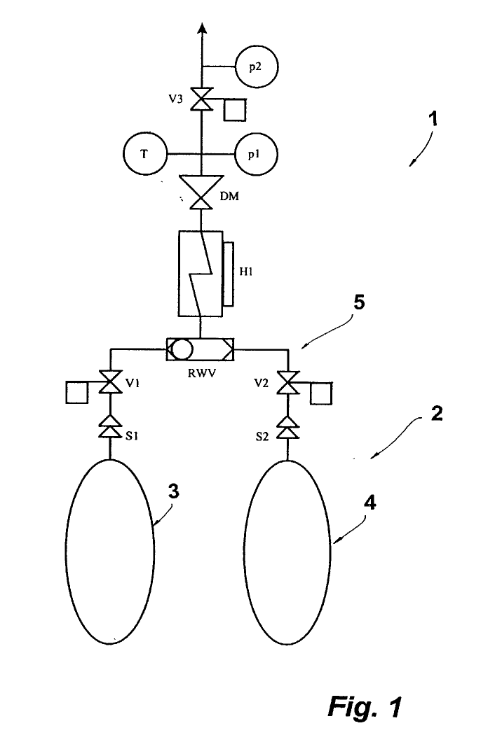

In the case of the embodiment example depicted in FIG. 1, the particular interchangeable NH₃ container 3 or 4 in connection with vaporizer H₁ serves simultaneously as a buffer container for buffering out the pressure peaks generated during the vaporization of liquid NH₃ in vaporizer H₁. For this purpose the line section disposed between vaporizer H₁ and in each instance one of the interchangeable NH₃ containers is conducting in both directions.

Instead of the implementation depicted in FIG. 1 a buffer container can also be a separate container, which is connected in the NH₃ supply line between an interchangeable NH₃ container and the vaporizer (not shown). In such a case the interchangeable NH₃container can be secured with its own check valve.

Although the present invention has been described with reference to preferred embodiments, numerous modifications and variations can be made and still the result will come within the scope of the invention. No limitation with respect to the specific embodiments disclosed herein is intended or should be inferred. Each apparatus embodiment described herein has numerous equivalents.

LIST OF REFERENCE SYMBOLS

1 Device

2 Docking station

3 Interchangeable NH₃ container

4 Interchangeable NH₃ container

5 Supply line system

DM Pressure reducer

H₁ Vaporizer

P₁ Pressure sensor

P₂ Pressure sensor

RWV Shuttle check valve

S₁ Quick coupling

S₂ Quick coupling

T Temperature sensor

V₁ Main valve

V₂ Main valve

V₃ Dosing valve

I claim:

1. A device for dosing a gaseous reducing agent for a supply into an exhaust gas system of a diesel engine, the device comprising:
a line terminating in the exhaust gas system, in which are connected in the direction of supply of the reducing agent a vaporizer, a pressure reducer as well as a dosing valve, and a buffer container which is connected in the supply line and precedes the pressure reducer.

2. The device as claimed in claim 1, wherein the buffer container precedes the vaporizer in the direction of supply.

3. Device as claimed in claim 2, wherein the buffer container is a reducing agent tank, in which the reducing agent required for the dosing is stored.

4. Device as claimed in one of claims 1 to 3, wherein the reducing agent is ammonia (NH₃).
